(19) United States
(12) Patent Application Publication
(10) Pub. No.: US 2013/0169548 A1
(43) Pub. Date: Jul. 4, 2013

(54) TOUCH PANEL

(71) Applicants: Hyun Jun Kim, Gyunggi-do (KR); Youn Soo Kim, Seoul (KR); Ho Joon Park, Seoul (KR)

(72) Inventors: Hyun Jun Kim, Gyunggi-do (KR); Youn Soo Kim, Seoul (KR); Ho Joon Park, Seoul (KR)

(73) Assignee: SAMSUNG ELECTRO-MECHANICS CO., LTD., Gyunggi-do (KR)

(21) Appl. No.: 13/425,518

(22) Filed: Mar. 21, 2012

(30) Foreign Application Priority Data
Dec. 30, 2011 (KR) 1020110146801

(51) Int. Cl. G06F 3/041

(52) U.S. Cl. 345/173

(57) ABSTRACT

Disclosed herein is a touch panel, including a transparent substrate; first electrode patterns formed in a mesh pattern on one surface of the transparent substrate; second electrode patterns formed in a surface type on the other surface of the transparent substrate; and an image display device provided in a direction of the other surface of the transparent substrate, thereby effectively blocking noise generated in the image display device, lowering a sheet resistance, and improving visibility.

### CROSS REFERENCE TO RELATED APPLICATION

This application claims the benefit of Korean Patent Application No. 10-2011-0146801, filed on Dec. 30, 2011, entitled “Touch Panel”, which is hereby incorporated by reference in its entirety into this application.

### BACKGROUND OF THE INVENTION

1. Technical Field

The present invention relates to a touch panel.

2. Description of the Related Art

With the growth of computers using digital technology, devices assisting the computers have also been developed, and personal computers, portable transmitters and other personal information processors execute processing of text and graphics using a variety of input devices such as a keyboard, a mouse and so on.

While the rapid advancement of an information-oriented society has been widening the use of computers more and more, it has become a problem to efficiently operate products using only the keyboard and mouse as being currently responsible for the input device function. Thus, the demand for a device that is simple, has minimum malfunction, and has the capability to easily input information is increasing.

Furthermore, current techniques for input devices exceed the level of fulfilling general functions and thus are progressing towards high reliability, durability, innovation, designing and manufacturing related techniques, etc. To this end, a touch panel has been developed as an input device capable of inputting information such as text and graphics, etc.

The touch panel is mounted on the display surface of an image display device such as an electronic organizer, a flat panel display including a liquid crystal display (LCD), a plasma display panel (PDP), an electroluminescence (El) element, or the like, or a cathode ray tube (CRT), so that a user selects desired information while viewing the image display device.

The touch panel is classified into a resistive type, a capacitive type, an electromagnetic type, a surface acoustic wave (SAW) type, and an infrared type. The type of touch panel selected is one that is adapted for an electronic product in consideration of not only signal amplification problems, resolution differences and the degree of difficulty of designing and manufacturing technology but also in light of optical properties, electrical properties, mechanical properties, resistance to the environment, input properties, durability and economic benefits of the touch panel. In particular, resistive and capacitive types are prevalently used at the present time.

Currently, an indium-thin oxide (ITO), a conductive polymer, or the like is used for a transparent electrode in a capacitive type touch panel. However, there occur high sheet resistance problems in the electrode made of ITO or the conductive polymer.

Furthermore, a touch panel employing a low-resistance metal mesh type transparent electrode is being considered in order to solve the problems.

However, in a case where the touch panel employing the metal mesh transparent electrode uses the existing electrode pattern shape itself, noise blocking performance by a lower plate is deteriorated and a rear surface touch problem may occur.

Moreover, it is difficult to utilize low resistance characteristics of the metal mesh due to the use of narrow patterns of an upper plate.

### SUMMARY OF THE INVENTION

The present invention has been made in an effort to provide a touch panel capable of lowering a channel resistance by employing a large-width first electrode pattern formed in a mesh pattern, and effectively blocking noise generated in an image display device by employing a second electrode pattern formed in a surface type.

According to a preferred embodiment of the present invention, there is provided a touch panel, including: a transparent substrate; first electrode patterns formed in a mesh pattern on one surface of the transparent substrate; second electrode patterns formed in a surface type on the other surface of the transparent substrate; and an image display device provided in a direction of the other surface of the transparent substrate.

The touch panel may further include dummy patterns formed in a mesh pattern between the first electrode patterns.

The touch panel may further include insulation lines each formed between the first electrode pattern and the dummy pattern.

The first electrode pattern may be formed of copper (Cu), aluminum (Al), gold (Au), silver (Ag), titanium (Ti), palladium (Pd), chrome (Cr), or a combination thereof.

The first electrode pattern may be formed of metal silver formed by exposing/developing a silver salt emulsion layer.

The second electrode pattern may be formed of poly-3,4-ethylenedioxythiophene/polystyrenesulfonate (PEDOT/PSS), polyaniline, polyacetylene, or polyphenylenevinylene.

The second electrode pattern may be formed of indium-thin oxide.

According to another preferred embodiment of the present invention, there is provided a touch panel, including: a first transparent substrate; first electrode patterns formed in a mesh pattern on one surface of the first transparent substrate; a second transparent substrate; second electrode patterns formed in a surface type on one surface of the second transparent substrate; an adhesive layer attaching one surface of the transparent substrate and one surface of the second transparent substrate to each other; and an image display device provided in a direction of the other surface of the second transparent substrate.

The touch panel may further include dummy patterns formed in a mesh pattern between the first electrode patterns.

The touch panel may further include insulation lines each formed between the first electrode pattern and the dummy pattern.

The first electrode pattern may be formed of copper (Cu), aluminum (Al), gold (Au), silver (Ag), titanium (Ti), palladium (Pd), chrome (Cr), or a combination thereof.

The first electrode pattern may be formed of metal silver formed by exposing/developing a silver salt emulsion layer.

The second electrode pattern may be formed of poly-3,4-ethylenedioxythiophene/polystyrenesulfonate (PEDOT/PSS), polyaniline, polyacetylene, or polyphenylenevinylene.

The second electrode pattern may be formed of indium-thin oxide.

According to still another preferred embodiment of the present invention, there is provided a touch panel, including: a transparent substrate; first electrode patterns formed in a mesh pattern on one surface of the transparent substrate; an insulating layer formed on one surface of the transparent substrate; second electrode patterns formed in a surface type on an exposed surface of the insulating layer; and an image display device provided in a direction of the exposed surface of the insulating layer.

The touch panel may further include dummy patterns formed in a mesh pattern between the first electrode patterns.

The touch panel may further include insulation lines each formed between the first electrode pattern and the dummy pattern.

The first electrode pattern may be formed of copper (Cu), aluminum (Al), gold (Au), silver (Ag), titanium (Ti), palladium (Pd), chrome (Cr), or a combination thereof.

The first electrode pattern may be formed of metal silver formed by exposing/developing a silver salt emulsion layer.

The second electrode pattern may be formed of poly-3,4-ethylenedioxythiophene/polystyrenesulfonate (PEDOT/PSS), polyaniline, polyacetylene, or polyphenylenevinylene.

### BRIEF DESCRIPTION OF THE DRAWINGS

FIG. 1 is an exploded perspective view of a touch panel according to a first preferred embodiment of the present invention;

FIG. 2 is a cross sectional view of the touch panel according to the first preferred embodiment of the present invention;

FIG. 3 is an exploded perspective view of a touch panel according to a second preferred embodiment of the present invention;

FIG. 4 is a cross sectional view of the touch panel according to the second preferred embodiment of the present invention;

FIG. 5 is an exploded perspective view of a touch panel according to a third preferred embodiment of the present invention; and

FIG. 6 is a cross-sectional view of the touch screen according to the third preferred third embodiment of the present invention.

### DESCRIPTION OF THE PREFERRED EMBODIMENTS

Various objects, advantages, and features of the invention will become apparent from the following description of preferred embodiments with reference to the accompanying drawings.

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe most appropriately the best method he or she knows for carrying out the invention.

The above and other objects, features and advantages of the present invention will be more clearly understood from the following detailed description taken in conjunction with the accompanying drawings. In the specification, in adding reference numerals to components throughout the drawings, it is to be noted that like reference numerals designate like components even though components are shown in different drawings. In the description, the terms “first”, “second”, “one surface”, “the other surface” and so on are used to distinguish one element from another element, and the elements are not defined by the above terms. Further, in describing the present invention, a detailed description of related known art related to the present invention will be omitted so as not to unnecessarily obscure the subject of the present invention.

Hereafter, preferred embodiments of the present invention will be described in detail with reference to the accompanying drawings.

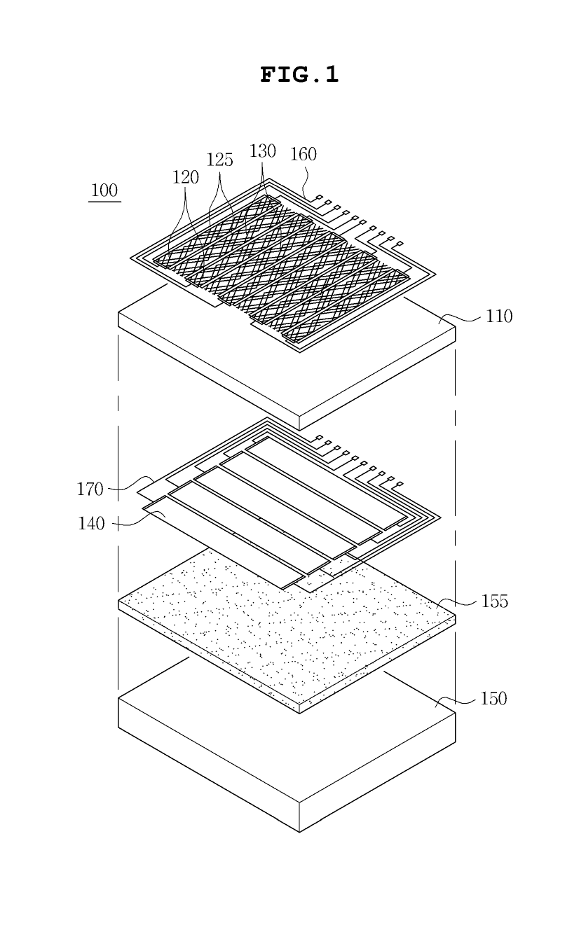

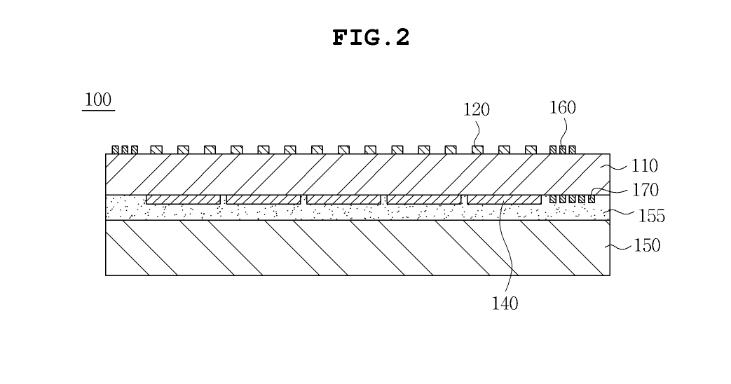

FIG. 1 is an exploded perspective view of a touch panel according to a first preferred embodiment of the present invention; and FIG. 2 is a cross sectional view of the touch panel according to the first preferred embodiment of the present invention.

As shown in FIGS. 1 and 2, a touch panel 100 according to the present preferred embodiment includes a transparent substrate 110, first electrode patterns 120 formed in a mesh pattern on one surface of the transparent substrate 110, second electrode patterns 140 formed in a surface type on the other surface of the transparent substrate 110, and an image display device 150 provided in a direction of the other surface of the transparent substrate 110.

The transparent substrate 110 serves to provide regions in which the first and second transparent electrode patterns 120 and 140 are to be formed. Here, the transparent substrate 110 needs to have a support force by which the first and second transparent electrode patterns 120 and 140 can be supported and transparency by which an image supplied from the image display device 150 can be recognized by a user. In consideration of the above-described support force and transparency, the transparent substrate 110 may be preferably formed of polyethyleneterephthalate (PET), polycarbonate (PC), polymethylmethacrylate (PMMA), polyethylenenaphthalate (PEN), polyethersulfone (PES), cyclic olefin copolymer (COC), a triacetylcellulose (TAC) film, polyvinyl alcohol (PVA) film, a polyimide (PI) film, polystyrene (PS), biaxially oriented polystyrene (BOPS; containing K resin), glass or reinforced glass, or the like, but is not necessarily limited thereto.

Meanwhile, high frequency treatment or primer treatment is preferably performed in order to activate both surfaces of the transparent substrate 110. Adhesive strength between the transparent substrate 110 and the first and second electrode patterns 120 and 140 can be improved by activating both surfaces of the transparent substrate 110 as described above.

The first electrode patterns 120 and the second electrode patterns 140 generate signals when touched by a user, thereby allowing a controller to recognize touch coordinates. Here, the first electrode patterns 120 are formed on one surface of the transparent substrate 110 and the second electrode patterns 140 are formed on the other surface of the transparent substrate 110, and thus, they face each other with the transparent substrate 110 therebetween.

Specifically, the first electrode pattern 120 may be formed in a mesh pattern by using copper (Cu), aluminum (Al), gold (Au), silver (Ag), titanium (Ti), palladium (Pd), chrome (Cr), or a combination thereof. Here, the first electrode pattern 120 may be formed by a plating process or a depositing process. Meanwhile, in a case where the first electrode pattern 120 is formed of copper (Cu), it is preferable to perform blackened treatment on a surface of the first electrode pattern 120. Here, according to the blackened treatment, the surface of the first electrode pattern 120 is oxidized to precipitate Cu₂O or CuO. Cu₂O is called brown oxide because it exhibits brown color, and CuO is called black oxide because it exhibits black color. As such, the blackened treatment is performed on the surface of the first electrode pattern 120, thereby preventing light from being reflected, and thus improving visibility of the touch panel 100.

In addition, the first electrode patterns 120 are formed to have a critical dimension of 7 μm or less and a pitch of 900 μm or less, thereby improving visibility. However, the critical dimension and the pitch of the electrode patterns 120 according to the first preferred embodiment of the present invention are not limited thereto.

Meanwhile, the first electrode pattern 120 may be formed of, besides the above-described metal, metal silver formed by exposing/developing a silver salt emulsion layer.

In addition, the touch panel 100 according to the first preferred embodiment of the present invention may further include dummy patterns 130 each formed in a mesh pattern between the first electrode patterns 120. Here, insulation lines 125 each may be formed between the first electrode pattern 120 and the dummy pattern 130.

As a result, a mesh pattern is formed above the touch panel 100, and the insulation lines are formed in a plurality of rows or lines. First electrode wirings 160 are selectively connected to plural portions demarcated by the insulation lines.

Here, among a plurality of mesh pattern portions, selected portions to which the first electrode wirings 160 are selectively connected are constituted of the first electrode patterns 120, and non-selected portions to which the first electrode wirings 160 are not connected are constituted of the dummy patterns 130. Here, the first electrode wiring 160 and the dummy pattern 130 may be formed of the same material and in the same pattern.

Therefore, large-width first electrode patterns 120 and floating state dummy patterns 130 may be formed by the mere formations of the insulation lines on the mesh pattern and connection of the first electrode wirings 160.

Accordingly, spatial uniformity can be secured and visibility can be improved, and further additive dummy patterns for obtaining a change in a liner touch signal does not need to be designed.

In addition, the second electrode pattern 140 may be formed in a surface type by using a conductive polymer or metal oxide.

Here, the conductive polymer has excellent flexibility and a coating process thereof is simple. Here, examples of the conductive polymer may include poly-3,4-ethylenedioxythiophene/polystyrenesulfonate (PEDOT/PSS), polyaniline, polyacetylene, or polyphenylenevinylene.

In addition, the metal oxide is made of indium-thin oxide.

In addition to this, the second electrode pattern 140 may be formed by a drying process, a wetting process, or a direct patterning process. Here, the drying process means sputtering, evaporation, or the like, the wetting process means dip coating, spin coating, roll coating, spray coating, or the like, the direct patterning process means screen printing, gravure printing, inkjet printing, or the like.

As described above, the first electrode pattern 120 is formed in a mesh pattern, and thus, a channel resistance thereof can be lowered. However, since opening portions are present in this mesh pattern, noise generated in the image display device 150 may be difficult to block.

However, since the second electrode pattern 140 is formed in a surface type on the other surface of the transparent substrate 110, noise generated in the image display device 150 can be effectively blocked, thereby preventing generation of electromagnetic interference (EMI).

Meanwhile, the first electrode pattern 120 and the second electrode pattern 140 are formed in a bar-shaped pattern on the drawings, but are not limited thereto. For example, the first electrode pattern 120 and the second electrode pattern 140 may be formed in any pattern known to the art, such as a diamond pattern, a square pattern, a triangle pattern, a circle pattern, or the like.

The image display device 150 serves to output an image, and provided in a direction of the other surface of the transparent substrate 110. Here, examples of the image display device 150 may include a liquid crystal display (LCD), a plasma display panel (PDP), an electroluminescence (EL), a cathode ray tube (CRT), or the like. In addition, the image display device 150 may be attached on the other surface of the transparent substrate 110 by an optical clear adhesive (OCA) 155. Meanwhile, noise may be generated in the image display device 150. However, as described above, the second electrode pattern 140 formed in a surface type can block the noise, thereby preventing the generation of electromagnetic interference (EMI).

Further, the first electrode wirings 160 are formed at the outer peripheral region of the first electrode patterns 120 to receive electric signals from the first electrode patterns 120, and the second electrode wirings 170 are formed at the outer peripheral region of the second electrode patterns 140 to receive electric signals from the second electrode patterns 140. Here, the first electrode wiring 160 and the first electrode pattern 120 are formed as one body, and the second electrode wiring 170 and the second electrode pattern 140 are formed as one body, so that the manufacturing process is simplified and the lead time can be shortened.

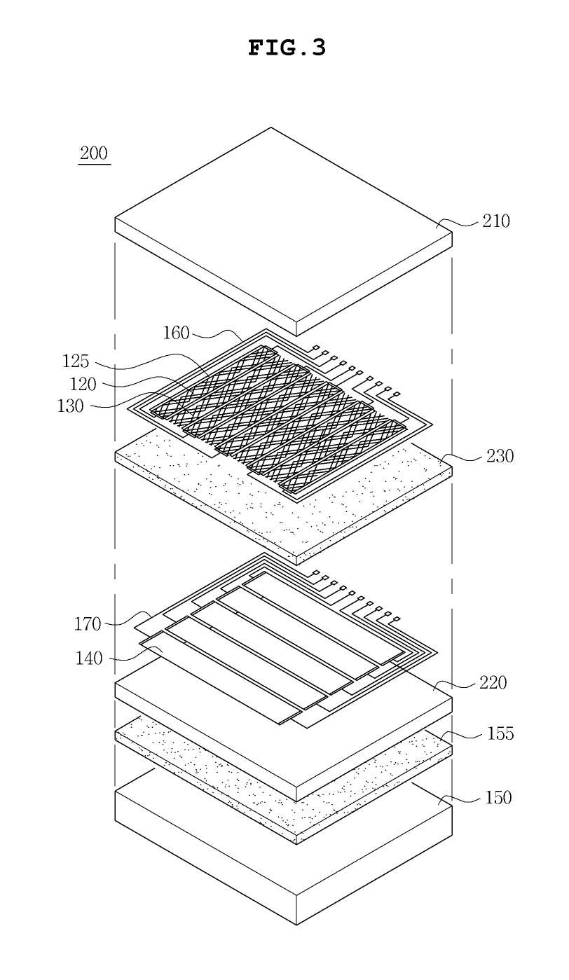

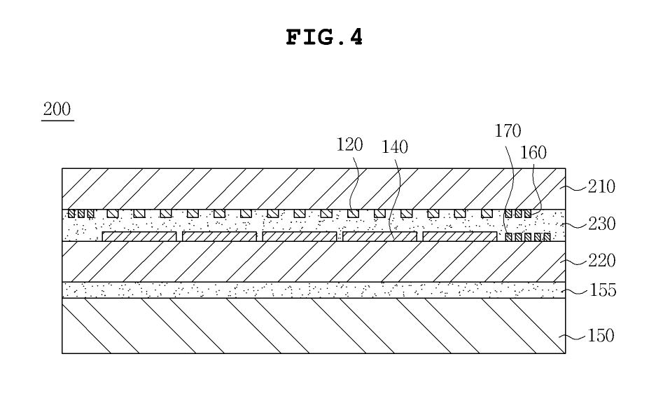

FIG. 3 is an exploded perspective view of a touch panel according to a second preferred embodiment of the present invention; and FIG. 4 is a cross sectional view of the touch panel according to the second preferred embodiment of the present invention.

As shown in FIGS. 3 and 4, a touch panel 200 according to the present preferred embodiment includes a first transparent substrate 210, first electrode patterns 120 formed in a mesh pattern on one surface of the first transparent substrate 210, a second transparent substrate 220, second electrode patterns 140 formed in a surface type on one surface of a second transparent substrate 220, an adhesive layer 230 attaching the other surface of the first transparent substrate 210 and one surface of the second transparent substrate 220 therethrough, and an image display device 150 provided in a direction of the other surface of the second transparent substrate 220.

The touch panel 200 according to the present embodiment is different from the above-described touch panel 100 according to the first preferred embodiment in that the first electrode patterns 120 are formed on the first transparent substrate 210 and the second electrode patterns 140 are formed on the second transparent substrate 220. Therefore, descriptions of the present preferred embodiment overlapping those of the first preferred embodiment will be simplified, and differences therebetween will be mainly described.

The first and second transparent substrates 210 and 220 serve to provide regions in which the first and second transparent electrodes 120 and 140 are to be formed. Here, high frequency treatment or primer treatment is preferably performed in order to activate one surface of the transparent substrate 210 and one surface of the second transparent substrate 220. Adhesive strength between the first and second transparent substrates 210 and 220 and the first and second electrode patterns 120 and 140 can be improved by activating the surfaces of the first and second transparent substrates 210 and 220, as described above.

Meanwhile, the first transparent substrate 210 may be a window provided at the outermost part of the touch panel 200. In a case where the first transparent substrate 210 is the window, the first electrode patterns 120 are formed directly on the window. Hence, processes of forming the first electrode patterns 120 on the transparent substrate and then attaching it to the window are omitted, and thus, the manufacturing process can be simplified and the entire thickness of the touch panel 200 can be decreased.

The first electrode pattern 120 and the second electrode pattern 140 generate signals when touched by a user, thereby allowing a controller to recognize touch coordinates. Here, the first electrode patterns 120 are formed on one surface of the transparent substrate 210 and the second electrode patterns 140 are formed on one surface of the second transparent substrate 220, and thus, they face each other with the adhesive layer 230 therebetween.

Specifically, the first electrode pattern 120 may be formed in a mesh pattern by using copper (Cu), aluminum (Al), gold (Au), silver (Ag), titanium (Ti), palladium (Pd), chrome (Cr), or a combination thereof. Meanwhile, in a case where the first electrode pattern 120 is formed of copper (Cu), it is preferable to perform blackened treatment on a surface of the first electrode pattern 120, so as to prevent light from being deflected.

In addition, the first electrode pattern 120 is formed to have a critical dimension of 7 μlm or less and a pitch of 900 μlm or less, thereby improving visibility. However, the critical dimension and the pitch of the electrode pattern 120 according to the second preferred embodiment of the present invention are not limited thereto.

Meanwhile, the first electrode pattern 120 may be formed of, besides the above-described metal, metal silver formed by exposing/developing a silver salt emulsion layer.

In addition, the touch panel 200 according to the second preferred embodiment of the present invention may further include dummy patterns 130 each formed in a mesh pattern between the first electrode patterns 120. Here, insulation lines 125 each may be formed between the first electrode pattern 120 and the dummy pattern 130.

As a result, mesh patterns are formed above the touch panel 200, and the insulation lines are formed in a plurality of rows or lines. First electrode wirings 160 are selectively connected to plural portions demarcated by the insulation lines.

Here, the portions of the plural mesh pattern portions to which the first electrode wirings 160 are selectively connected are constituted of the first electrode patterns 120, and the portions of the plural mesh pattern portions to which the first electrode wirings 160 are not connected are constituted of the dummy patterns 130. Here, the first electrode wiring 160 and the dummy pattern 130 may be formed of the same material and in the same pattern.

Therefore, large-width first electrode patterns 120 and floating state dummy patterns 130 may be formed by the mere formations of the insulation lines on the mesh pattern and connection of the first electrode wirings 160.

Accordingly, spatial uniformity can be secured and visibility can be improved, and further additive dummy patterns for obtaining a change in a linear touch signal does not need to be designed.

In addition, the second electrode pattern 140 may be formed in a surface type by using a conductive polymer or metal oxide.

Here, the conductive polymer has excellent flexibility and a coating process thereof is simple. Here, examples of the conductive polymer may include poly-3,4-ethylenedioxythiophene/polystyrenesulfonate (PEDOT/PSS), polyaniline, polyacetylene, or polyphenylenevinylene.

In addition, the metal oxide is made of indium-thin oxide.

In addition to this, the second electrode pattern 140 may be formed by a drying process, a wetting process, or a direct patterning process. Here, the drying process means sputtering, evaporation, or the like, the wetting process means dip coating, spin coating, roll coating, spray coating, or the like, the direct patterning process means screen printing, gravure printing, inkjet printing, or the like.

As described above, the first electrode pattern 120 is formed in a mesh pattern, and thus, a sheet resistance thereof can be lowered. However, since opening portions are present in this mesh pattern, noise generated in the image display device 150 may be difficult to block.

However, since the second electrode pattern 140 is formed in a surface type on the other surface of the transparent substrate 110, noise generated in the image display device 150 can be effectively blocked, thereby preventing generation of electromagnetic interference (EMI).

The adhesive layer 230 attaches one surface of the first transparent substrate 210 and one surface of the second transparent electrode 220 to each other, so that the first electrode pattern 120 and the second electrode pattern 140 are disposed to face each other. Here, the first adhesive layer 230 is not particularly limited, but an optical clear adhesive (OCA) may be used therefor.

The image display device 150 serves to output an image, and provided in a direction of the other surface of the second transparent substrate 220. Here, the image display device 150 may be attached on the other surface of the second transparent substrate 220 by the optical clear adhesive (OCA) 155.

Further, the first electrode wirings 160 are formed at the outer peripheral region of the first electrode patterns 120 to receive electric signals from the first electrode patterns 120, and the second electrode wirings 170 are formed at the outer peripheral region of the second electrode patterns 140 to receive electric signals from the second electrode patterns 140. Here, the first electrode wiring 160 and the first electrode pattern 120 are formed as one body, and the second electrode wiring 170 and the second electrode pattern 140 are formed as one body, so that the manufacturing process is simplified and the lead time can be shortened.

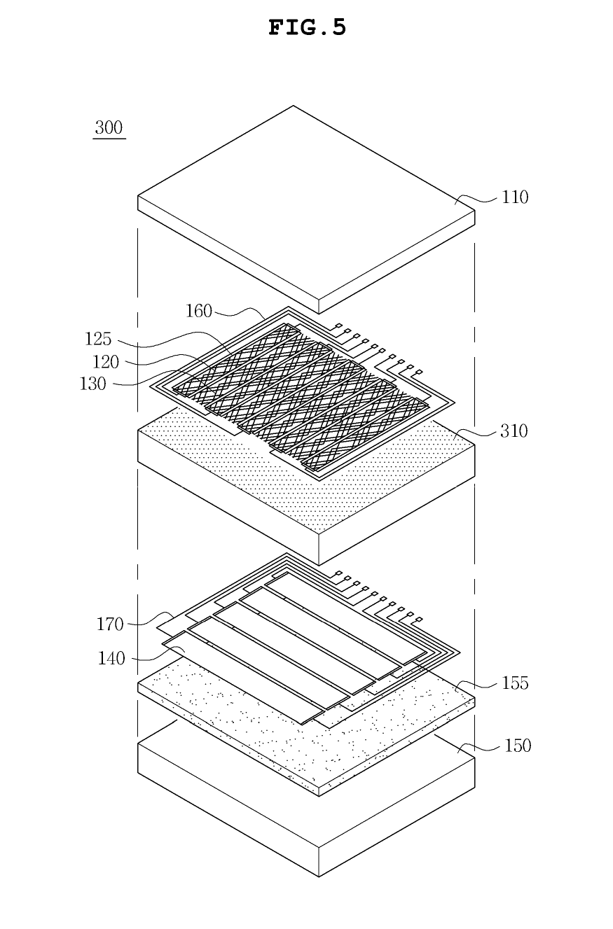

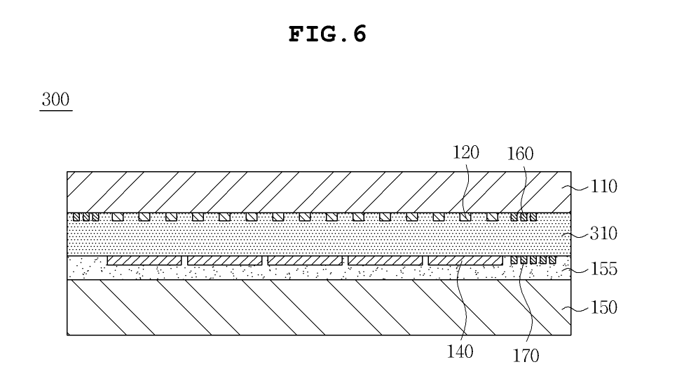

FIG. 5 is an exploded perspective view of a touch panel according to a third preferred embodiment of the present invention; and FIG. 6 is a cross sectional view of the touch panel according to the third preferred embodiment of the present invention.

As shown in FIGS. 5 and 6, a touch panel 300 according to the present preferred embodiment includes a transparent substrate 110, first electrode patterns 120 formed in a mesh pattern on one surface of the transparent substrate 110, an insulating layer 310 formed on one surface of the transparent substrate 110, second electrode patterns 140 formed in a surface type on an exposed surface of the insulating layer 310, and an image display device 150 provided in a direction of the exposed surface of the insulting layer 310.

The touch panel 300 according to the present embodiment is different from the above-described touch panel 300 according to the second preferred embodiment in that the first electrode patterns 120 are formed on the transparent substrate 110 and the second electrode patterns 140 are formed on the insulating layer 310. Therefore, descriptions of the present preferred embodiment overlapping those of the first and second preferred embodiments will be simplified, and differences therebetween will be mainly described.

The transparent substrate 110 serves to provide a region in which the first transparent electrodes 120 are to be formed. Here, high frequency treatment or primer treatment is preferably performed in order to activate one surface of the transparent substrate 110. Adhesive strength between the transparent substrate 110 and the first electrode patterns 120 can be improved by activating one surface of the transparent substrate 110, as described above.

Meanwhile, the transparent substrate 110 may be a window provided at the outermost part of the touch panel 300. In a case where the transparent substrate 110 is the window, the first electrode patterns 120 are formed directly on the window. Hence, processes of forming the first electrode patterns 120 on a separate transparent substrate and then attaching it to the window are omitted, and thus, the manufacturing process can be simplified and the entire thickness of the touch panel 300 can be decreased.

The insulating layer 310 serves to protect the first electrode patterns 120 and provide a region in which the second electrode patterns 140 are to be formed. The insulating layer 310 is formed on one surface of the transparent substrate 110 so as to cover the first electrode patterns 120. Here, the insulating layer 310 may be formed by printing, chemical vapor deposition (CVD), sputtering, or the like, and may be formed of epoxy or acrylic resins, a SiOx thin film, a SiNx thin film, or the like.

The first electrode pattern 120 and the second electrode pattern 140 generate signals when touched by a user, thereby allowing a controller to recognize touch coordinates. Here, the first electrode pattern 120 is formed on one surface of the transparent substrate 110 and the second electrode pattern 140 is formed on the other surface of the transparent substrate 310, and thus, they face each other with the insulating layer 310 therebetween.

Specifically, the first electrode pattern 120 may be formed in a mesh pattern by using copper (Cu), aluminum (Al), gold (Au), silver (Ag), titanium (Ti), palladium (Pd), chrome (Cr), or a combination thereof. Meanwhile, in a case where the first electrode pattern 120 is formed of copper (Cu), it is preferable to perform blackened treatment on a surface of the first electrode pattern 120, so as to prevent light from being deflected.

In addition, the first electrode pattern 120 is formed to have a critical dimension of 7 μm or less and a pitch of 900 μm or less, thereby improving visibility. However, the critical dimension and the pitch of the electrode pattern 120 according to the third preferred embodiment of the present invention are not limited thereto.

Meanwhile, the first electrode pattern 120 may be formed of, besides the above-described metal, metal silver formed by exposing/developing a silver salt emulsion layer.

In addition, the touch panel 300 according to the third preferred embodiment of the present invention may further include dummy patterns 130 each formed in a mesh pattern between the first electrode patterns 120. Here, insulation lines 125 each may be formed between the first electrode pattern 120 and the dummy pattern 130.

As a result, mesh patterns are formed above the touch panel 300, and the insulation lines are formed in a plurality of rows or lines. First electrode wirings 160 are selectively connected to plural portions demarcated by the insulation lines.

Here, the portions of the plural mesh pattern portions to which the first electrode wirings 160 are selectively connected are constituted of the first electrode patterns 120, and the portions of the plural mesh pattern portions to which the first electrode wirings 160 are not connected are constituted of the dummy patterns 130. Here, the first electrode wiring 160 and the dummy pattern 130 may be formed of the same material and in the same pattern.

Therefore, large-width first electrode patterns 120 and floating state dummy patterns 130 may be formed by mere formations of the insulation lines on the mesh pattern and connection of the first electrode wirings 160.

Accordingly, spatial uniformity can be secured and visibility can be improved, and further additive dummy patterns for obtaining a change in a liner touch signal does not need to be designed.

In addition, the second electrode pattern 140 may be formed in a surface type by using a conductive polymer or metal oxide.

Here, the conductive polymer has excellent flexibility and a coating process thereof is simple. Here, examples of the conductive polymer may include poly-3,4-ethylenedioxythiophene/polystyrenesulfonate (PEDOT/PSS), polyaniline, polyacetylene, or polyphenylenevinylene.

In addition, the metal oxide is made of indium-thin oxide.

In addition to this, the second electrode pattern 140 may be formed by a drying process, a wetting process, or a direct patterning process. Here, the drying process means sputtering, evaporation, or the like, the wetting process means dip coating, spin coating, roll coating, spray coating, or the like, the direct patterning process means screen printing, gravure printing, inkjet printing, or the like.

As described above, the first electrode pattern 120 is formed in a mesh pattern, and thus, a sheet resistance thereof can be lowered. However, since opening portions are present in this mesh pattern, noise generated in the image display device 150 may be difficult to block.

However, since the second electrode pattern 140 is formed in a surface type on the exposed surface of the insulating layer 310, noise generated in the image display device 150 can be effectively blocked, thereby preventing generation of electromagnetic interference (EMI).

The image display device 150 serves to output an image, and provided in a direction of the exposed surface of the insulating layer 310. In addition, the image display device 150 may be attached on the exposed surface of the insulating layer 310 by an optically clear adhesive (OCA) 155.

Further, the first electrode wirings 160 are formed at the outer peripheral region of the first electrode patterns 120 to receive electric signals from the first electrode patterns 120, and the second electrode wirings 170 are formed at the outer peripheral region of the second electrode patterns 140 to receive electric signals from the second electrode patterns 140. Here, the first electrode wiring 160 and the first electrode pattern 120 are formed as one body, and the second electrode wiring 170 and the second electrode pattern 140 are formed as one body, so that the manufacturing process is simplified and the lead time can be shortened.

According to the present invention, low-resistance characteristics can be sufficiently utilized by employing the first electrode pattern formed in a large-width mesh pattern above the touch panel.

Further, according to the present invention, LCD noise or the like generated in the image display device can be effectively blocked by employing the second electrode pattern formed in a surface type below the touch panel.

Further, according to the present invention, spatial uniformity can be secured by forming the entire of an upper surface of the touch panel in a mesh pattern, dividing the mesh pattern into a plurality of portions by using the insulation lines, and forming the first electrode patterns in selected portions and floating-state dummy patterns in non-selected portions. Therefore, visibility can be improved, and additive dummy patterns for obtaining changes in linear touch signals does not need to be designed.

Although the preferred embodiments of the present invention have been disclosed for illustrative purposes, they are for specifically explaining the present invention and thus a touch panel according to the present invention is not limited thereto, but those skilled in the art will appreciate that various modifications, additions and substitutions are possible, without departing from the scope and spirit of the invention as disclosed in the accompanying claims. Accordingly, any and all modifications, variations or equivalent arrangements should be considered to be within the scope of the invention, and the detailed scope of the invention will be disclosed by the accompanying claims.

What is claimed is:

1. A touch panel, comprising:
a transparent substrate;
first electrode patterns formed in a mesh pattern on one surface of the transparent substrate;
second electrode patterns formed in a surface type on the other surface of the transparent substrate; and
an image display device provided in a direction of the other surface of the transparent substrate.

2. The touch panel as set forth in claim 1, further comprising dummy patterns formed in a mesh pattern between the first electrode patterns.

3. The touch panel as set forth in claim 2, further comprising insulation lines each formed between the first electrode pattern and the dummy pattern.

4. The touch panel as set forth in claim 1, wherein the first electrode pattern is formed of copper (Cu), aluminum (Al), gold (Au), silver (Ag), titanium (Ti), palladium (Pd), chrome (Cr), or a combination thereof.

5. The touch panel as set forth in claim 1, wherein the first electrode pattern is formed of metal silver formed by exposing/developing a silver salt emulsion layer.

6. The touch panel as set forth in claim 1, wherein the second electrode pattern is formed of poly-3,4-ethylenedioxythiophene/polystyrenesulfonate (PEDOT/PSS), polyaniline, polyacetylene, or polyphenylenevinylene.

7. The touch panel as set forth in claim 1, wherein the second electrode pattern is formed of indium-thin oxide.

8. A touch panel, comprising:
a first transparent substrate;
first electrode patterns formed in a mesh pattern on one surface of the first transparent substrate;
a second transparent substrate;
second electrode patterns formed in a surface type on one surface of the second transparent substrate;
an adhesive layer attaching one surface of the transparent substrate and one surface of the second transparent substrate to each other; and
an image display device provided in a direction of the other surface of the second transparent substrate.

9. The touch panel as set forth in claim 8, further comprising dummy patterns formed in a mesh pattern between the first electrode patterns.

10. The touch panel as set forth in claim 9, further comprising insulation lines each formed between the first electrode pattern and the dummy pattern.

11. The touch panel as set forth in claim 8, wherein the first electrode pattern is formed of copper (Cu), aluminum (Al), gold (Au), silver (Ag), titanium (Ti), palladium (Pd), chrome (Cr), or a combination thereof.

12. The touch panel as set forth in claim 8, wherein the first electrode pattern is formed of metal silver formed by exposing/developing a silver salt emulsion layer.

13. The touch panel as set forth in claim 8, wherein the second electrode pattern is formed of poly-3,4-ethylenedioxythiophene/polystyrenesulfonate (PEDOT/PSS), polyaniline, polyacetylene, or polyphenylenevinylene.

14. The touch panel as set forth in claim 8, wherein the second electrode pattern is formed of indium-thin oxide.

15. A touch panel, comprising:
a transparent substrate;
first electrode patterns formed in a mesh pattern on one surface of the transparent substrate;
an insulating layer formed on one surface of the transparent substrate;
second electrode patterns formed in a surface type on an exposed surface of the insulating layer; and
an image display device provided in a direction of the exposed surface of the insulating layer.

16. The touch panel as set forth in claim 15, further comprising dummy patterns formed in a mesh pattern between the first electrode patterns.

17. The touch panel as set forth in claim 16, further comprising insulation lines each formed between the first electrode pattern and the dummy pattern.

18. The touch panel as set forth in claim 15, wherein the first electrode pattern is formed of copper (Cu), aluminum (Al), gold (Au), silver (Ag), titanium (Ti), palladium (Pd), chrome (Cr), or a combination thereof.

19. The touch panel as set forth in claim 15, wherein the first electrode pattern is formed of metal silver formed by exposing/developing a silver salt emulsion layer.

20. The touch panel as set forth in claim 15, wherein the second electrode pattern is formed of poly-3,4-ethylenedioxythiophene/polystyrenesulfonate (PEDOT/PSS), polyaniline, polyacetylene, or polyphenylenevinylene.
